(19) United States
(12) Patent Application Publication
(10) Pub. No.: US 2024/0414057 A1
(43) Pub. Date: Dec. 12, 2024

(54) SHARING RESOURCES BETWEEN NETWORK MANAGEMENT SERVICE USERS

(71) Applicant: VMware LLC, Palo Alto, CA (US)

(72) Inventors: Sachin Mohan Vaidya, Pune (IN); Thomas Pierre Labor Vigneron, San Jose, CA (US); Shailesh Makhijani, Pune (IN); Goutham Bodduluri, Vijayawada (IN); Nikhil Bokare, Pune (IN); Rushikesh Wagh, Pune (IN); Vaibhav Bhandari, Pune (IN)

(21) Appl. No.: 18/243,807

(22) Filed: Sep. 8, 2023

(30) Foreign Application Priority Data
Jun. 12, 2023 (IN) 202341040057

(51) Int. Cl. H04L 41/0894; H04L 41/0893

(52) U.S. Cl. CPC H04L 41/0894

(57) ABSTRACT

Some embodiments provide a method for managing logical network policy at a network management service that manages one or more logical networks, each of which is defined across one or more datacenters. From a first user that controls a first portion of a logical network, the method receives (i) a definition of a policy configuration object for the logical network and (ii) sharing of the policy configuration object with a second user that controls a second portion of the logical network. From the second user, the method receives definition of a service rule that uses the policy configuration object. The method distributes the service rule to a set of network element elements that implement the logical network at the one or more datacenters for the set of network elements to enforce the service rule.

### BACKGROUND

Network management services (e.g., policy management, network monitoring, etc.) primarily enable individual users for a logical network or, in some cases, multiple isolated users, to manage the logical networks. However, organizational structures may require multiple different users with different capabilities. Similarly, for a multi-tenant cloud, a provider might use a network management service to manage the datacenter(s). As numerous tenants of the datacenter will want to manage their own logical networks, the provider might want to enable such users on the network management service.

### BRIEF SUMMARY

Some embodiments of the invention provide a network management service (e.g., a network management and monitoring system) that manages logical network policy for one or more logical networks defined across one or more datacenters. For a given logical network, the network management service enables the creation of multiple users that control different (potentially overlapping) portions of the logical network. The different users are able to define various network forwarding and/or policy constructs and, in some cases, share these constructs with other users. This enables a user to define a policy construct and let another user make use of that policy construct while preventing the other user from modifying the policy construct (or, in some embodiments, even viewing details of the policy construct). In addition, the sharing feature enables one user to define a policy construct and share that construct across multiple users of the logical network rather than requiring every user to define the same construct.

In some embodiments, through an interface of the network management service, a first user that controls a first portion of the logical network can define a policy configuration object (e.g., a static or dynamic security group, a service definition, a DHCP profile, a service rule or set of service rules, etc.) and then specify that the policy configuration object be shared with one or more other users of the network management service that control different portions of the logical network. Additional users with which the policy configuration object is shared then have the ability to view the policy configuration object (e.g., through the network management service interface) and make use of that policy configuration object. For instance, the additional users can, in some embodiments, define a service rule using the policy configuration object.

To share a policy configuration object, in some embodiments the first user creates a shared object within the policy data model of the logical network, then associates the policy configuration object with the shared object. A user may associate multiple policy configuration objects (e.g., multiple security groups, multiple service definitions, combinations thereof, etc.) with the shared object. The first user also specifies the specific second user (or multiple users) that are provided access to the shared object.

The types of policy configuration objects that may be shared in some embodiments include security groups, service definitions, DHCP profiles, context profiles, and service rules, among others. Security groups include dynamic groups that define a set of criteria for a network endpoint (e.g., a virtual machine (VM), container, or other data compute node (DCN)) to belong to the group as well as static groups in which the user defining the group specifies a set of network endpoints or a set of network addresses that belong to the group. Security rules may be defined using the security group (by either the user that defines a security group or the user with which the security group is shared) by specifying the security rule as applying to data traffic sent either to or from the security group. While security groups are used to specify the sources and/or destinations to which security rules apply, service definitions specify the type of traffic to which the security rules apply. For instance, a user can define a particular service based on the destination transport layer port number so that security rules for that service only apply to traffic having that destination transport layer port number.

In some embodiments, the first user that shares the policy configuration object is a primary user for the logical network. This primary user creates the logical network via the network management service and defines the second user as a tenant (or sub-tenant user) in relation to the primary user. In some such embodiments, the network management service stores the logical network policy configuration as a policy tree. Within the policy tree for a primary user, the primary user defines sub-trees (also referred to as “projects”) for different tenant users. The network management service allows separate access for these tenant users in some embodiments, who are only able to access their portion of the policy configuration (i.e., their respective sub-trees). For instance, an organization can create separate policy configuration domains for different divisions within the organization (e.g., human resources, finance, research and development, etc.). Similarly, a service provider (e.g., a telecommunications service provider) can define tenant policy configuration domains for different customers of theirs. A tenant user can only access their own policy configuration domain and cannot view or modify the main policy configuration domain or the policy configuration domains of other sub-tenants. However, the primary user can (i) expose certain elements of the network configuration (e.g., logical routers that handle traffic ingressing and egressing the logical network) to the tenant users so that the tenant users can connect their networks to these elements and (ii) share policy configuration objects with the tenant users so that the tenant users can make use of these policy configurations within their own network policy.

This policy configuration data model may exist in different contexts in different embodiments. For example, in some embodiments the network management service is a multi-tenant network management service that operates in a public cloud to manage multiple different groups of datacenters. In this case, the network management service may have numerous primary users, each a tenant of the network management service with their own independent policy tree. Each primary tenant user defines a group of datacenters (or, in some cases, multiple independent groups of datacenters) and the network management service stores a separate policy tree for each datacenter group. In some embodiments, the network management service deploys a separate policy manager service instance in the public cloud to manage each datacenter group (and thus each separate policy tree).

In other embodiments, the network management service manages a single datacenter or associated group of datacenters (e.g., a set of physical datacenters owned by a single enterprise). In this case, the enterprise (e.g., a network or security administrator of the enterprise) may be the primary user, with the tenant users representing different departments of the enterprise, tenants of the enterprise (e.g., in the communications service provider context mentioned above), etc. In either case, the policy tree of some embodiments includes a primary tree for the primary user network policy configuration as well as separate sub-trees for the policy configurations of each tenant user.

In addition to a primary user sharing policy configuration with tenant users, some embodiments allow one tenant user to share policy configuration with other tenant users. In some such embodiments (and in some embodiments when primary users share policy configuration with tenant users), the user with which policy configuration is shared has the option to accept or decline the share. Thus, for example, if one tenant wishes to define a particular service differently within their portion of the logical network (e.g., using a different port number for a particular service), they can do so even if that service definition is shared with them.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a flow diagram of some embodiments that shows operations related to sharing of a policy construct.

FIG. 2 conceptually illustrates a logical network policy configuration of some embodiments.

FIG. 3 conceptually illustrates the logical network policy configuration after the primary tenant user has created a shared object.

FIG. 4 conceptually illustrates that the second security group has been associated with the shared object in the logical network policy configuration.

FIG. 5 conceptually illustrates that the primary user has now shared the shared object with the sub-tenant.

FIG. 6 conceptually illustrates a flow diagram of some embodiments that shows operations of the second tenant user, with which a policy configuration object is shared, using that shared policy configuration object.

FIG. 7 conceptually illustrates the logical network policy configuration after the sub-tenant has created a new security rule that uses the shared security group.

FIG. 8 conceptually illustrates the architecture of a cloud-based multi-tenant network management and monitoring system of some embodiments.

FIG. 9 conceptually illustrates an enterprise network management system of some embodiments.

FIG. 10 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a network management service (e.g., a network management and monitoring system) that manages logical network policy for one or more logical networks defined across one or more datacenters. For a given logical network, the network management service enables the creation of multiple users that control different (potentially overlapping) portions of the logical network. The different users are able to define various network forwarding and/or policy constructs and, in some cases, share these constructs with other users. This enables a user to define a policy construct and let another user make use of that policy construct while preventing the other user from modifying the policy construct (or, in some embodiments, even viewing details of the policy construct). In addition, the sharing feature enables one user to define a policy construct and share that construct across multiple users of the logical network rather than requiring every user to define the same construct.

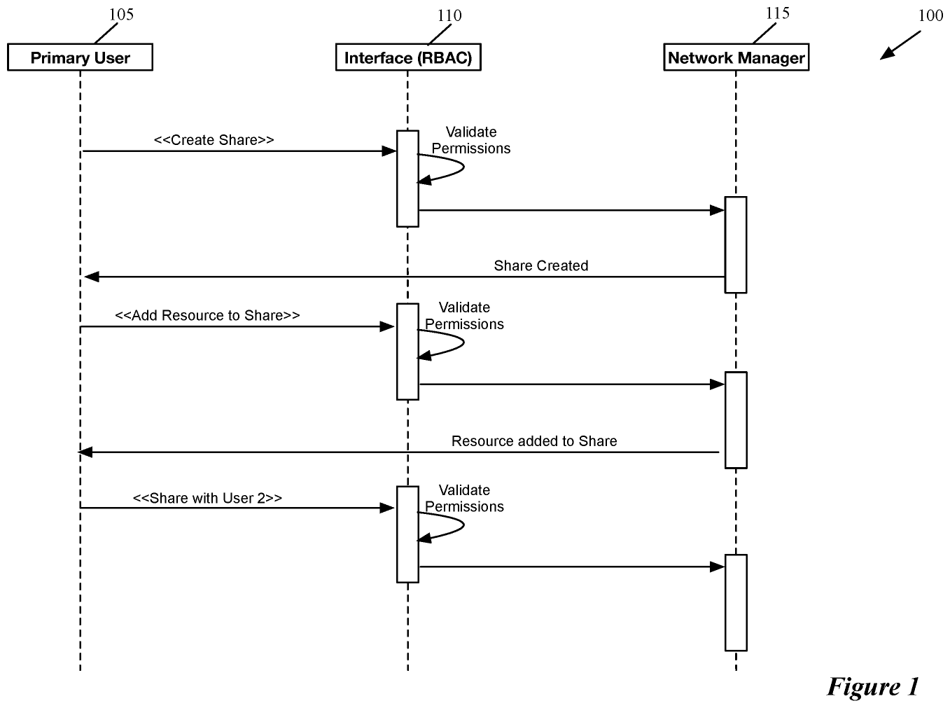

FIG. 1 conceptually illustrates a flow diagram 100 of some embodiments that shows operations related to sharing of a policy construct. In this diagram, the primary user 105 is a user that creates the policy construct with a network management service and shares that policy construct with another user. The interface 110 is a network management service interface that performs role-based access control (RBAC), which prevents users from accessing portions of the logical network (or other logical networks) to which they have not been granted access. The network manager 115 represents the network management service with which the user interacts in order to define and modify logical network policy within a set of one or more datacenters. In different contexts, this network manager 115 may represent different network management service entities (some such contexts are described below).

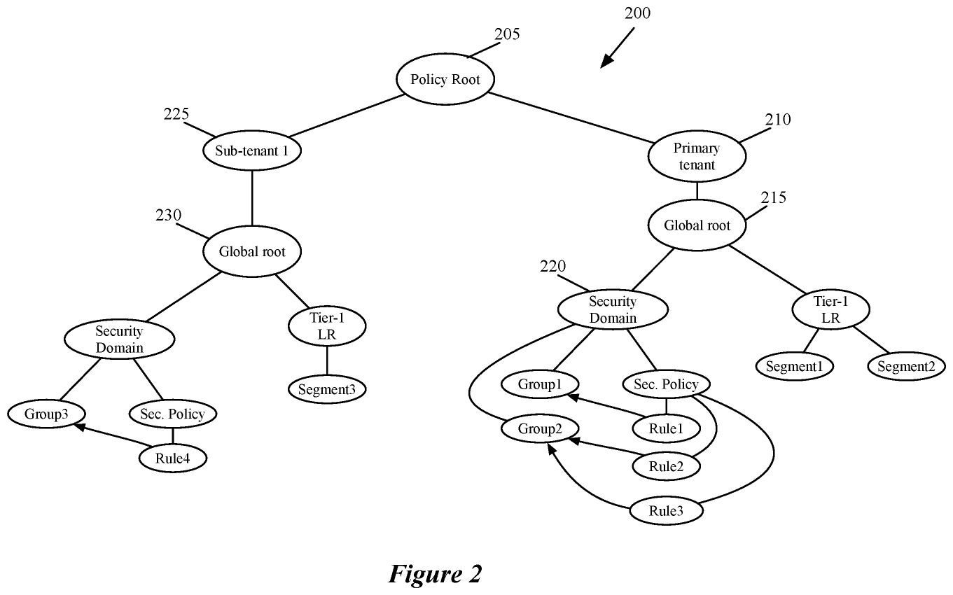

FIG. 2 conceptually illustrates a logical network policy configuration 200 of some embodiments, by reference to which the flow diagram 100 will be described. The flow diagram 100 begins after the primary user has (i) defined a logical network spanning one or more datacenters, (ii) defined a set of policy constructs for that logical network, and (iii) defined at least one additional user that manages their own portion of the logical network.

In some embodiments, the first user that shares the policy configuration object is a primary user for the logical network. This primary user creates the logical network via the network management service and defines the second user as a tenant (or sub-tenant user) in relation to the primary user. In some such embodiments, the network management service stores the logical network policy configuration as a policy tree. Within the policy tree for a primary user, the primary user defines sub-trees (also referred to as “projects”) for different tenant users. The network management service allows separate access for these tenant users in some embodiments, who are only able to access their portion of the policy configuration (i.e., their respective sub-trees).

As shown, the policy configuration (policy tree) 200 starts with a policy root node 205, under which a primary tenant root node 210 and a sub-tenant root node 225 are created. The primary tenant can create other users (e.g., the sub-tenant user) as well as define their own network policy. The primary tenant root node 210 has its own global root node 215 for the network policy, under which the network policy is defined. In this case, the primary user has defined a security domain 220 as well as a set of logical networking constructs. Specifically, the primary user has defined a logical router and a set of network segments (e.g., logical switches) that connect to the logical router). The logical router, in different embodiments, may be implemented in one or more datacenters spanned by the logical network, with each of the network segments confined to some or all of the datacenters spanned by the logical router.

In some embodiments, the security domain 220 is defined to apply to a set of one or more datacenters spanned by the logical network. In some embodiments, a user may define multiple security domains for a logical network, with different policy defined for each domain. Some embodiments also impose a restriction that, for a single tenant, each datacenter spanned by the logical network may only belong to one security domain. Other embodiments allow datacenters to belong to multiple security domains.

Within the security domain 220, the primary user defines a number of policy constructs. In this case, the user has defined two security groups as well as a security policy with three security rules that use these groups. Security groups, in some embodiments, include both dynamic groups and static groups. For dynamic groups, the user specifies a set of criteria for a network endpoint (e.g., a virtual machine (VM), container, or other data compute node (DCN)) to belong to the group. These criteria can be based on the operating system of the network endpoints, application implemented by the network endpoints, IP subnet, etc. Any network endpoints that meet those criteria within the datacenter(s) are automatically added to the security group, with membership in the group changing as network endpoints that meet the specified criteria are created or deleted. For static groups, on the other hand, the user defines a specific set of network endpoints or network addresses that belong to the group.

Other types of policy configuration objects, not shown in FIG. 2, include service definitions, context profiles, and DHCP profiles, among others. Service definitions can be used to specify a particular type of traffic (e.g., http or https traffic, ftp traffic, etc.). For instance, a user can define a particular service based on the destination transport layer port number associated with that traffic, or using other criteria. Context profiles, in some embodiments, specify one or more applications, as well as potentially sub-attributes (e.g., a TLS version). DHCP profiles, in some embodiments, specify a type of DHCP server and a configuration for that server or servers.

The security rules that the user defines may use the security groups (as in the rules that are defined within the security domain 220), the service definitions, and the context profiles in some embodiments. Security rules, in some embodiments, specify traffic to which the rule is applicable and an action (e.g., allow, drop, block) to take on that traffic, as well as a priority relative to other rules. To define a security rule, a user may specify a source and/or destination of that traffic (e.g., using the security groups or directly specifying network addresses), as well as the type of traffic to which the security rule applies (e.g., using the service definitions and/or context profiles). In the example shown in FIG. 2, one of the primary tenant's security rules uses a first security group while two of the security rules use a second security group (e.g., one rule using the group as the source and another rule using the group as the destination).

In addition, the primary tenant has created a sub-tenant, for which the network management service defines a separate root node 225 with its own global root node 230. In some embodiments, an organization can create separate policy configuration domains for different divisions within the organization (e.g., human resources, finance, research and development, etc.). For instance, the network administrator might manage the primary (primary tenant or provider) user of the logical network policy configuration and then create different tenant (sub-tenant) users for each business unit or other organizational division. Similarly, a service provider (e.g., a telecommunications service provider) can define sub-tenant policy configuration domains for different customers of theirs. A sub-tenant user can only access their own policy configuration domain and cannot view or modify the main policy configuration domain or the policy configuration domains of other sub-tenants.

The sub-tenant user has defined a security domain 235 as well as a logical router a network segment. In some embodiments, the sub-tenant user may link the logical networking constructs to certain logical networking constructs exposed by the provider (e.g., to a logical router that handles traffic ingressing and egressing the logical network).

The security domain 235 is defined to apply to a set of one or more datacenters spanned by the portion of the logical network over which the sub-tenant user has control. For instance, if the primary tenant user defines the sub-tenant user to only have access to a subset of datacenters, then the security domain 235 can only span datacenters within this subset. Within the security domain 235, the sub-tenant user has defined a security group as well as a security policy with one security rule that uses this group.

As a note, some embodiments define a separate global root node (e.g., nodes underneath each of the tenant root nodes because the tenant users (both the primary tenant user and sub-tenant users) may define their own sub-users (also referred to as “projects”). The projects may be isolated to subsets of the datacenters across which the tenant's logical network portion spans and may be restricted in terms of the networking and security policies that may be defined within a project.

These sub-users may also receive shared policy configuration objects. Some embodiments allow the users (e.g., a primary user, sub-tenant users, or sub-users of the sub-tenants) to define application developer users. An application developer user, in some embodiments, is able to create distributed applications in a portion of the logical network designated by the user that creates the application developer user (which must be constrained to the portion of the logical network over which that user has control). In some embodiments, the application developer users have no authorization to define (or even view) security policy, but can define applications to be deployed within the network. These various different types of users are described in more detail in U.S. Pat. No. 11,601,474, entitled “Network Virtualization Infrastructure With Divided User Responsibilities”, which is incorporated by reference herein.

Returning to FIG. 1, as shown, the primary user 105 begins the process of sharing a policy construct (that has previously been defined) by sending a command to the network manager 115, via the interface 110, to create a share. The interface 110 validates the permissions of the primary user 105 to verify that the user has the authority to access and modify the logical network. Once the user is validated, the interface 110 provides the command to the network manager 115. The network manager 115 creates the share in the logical network policy configuration and notifies the user 105 (via the interface 110), who can now view the created share object in their user interface.

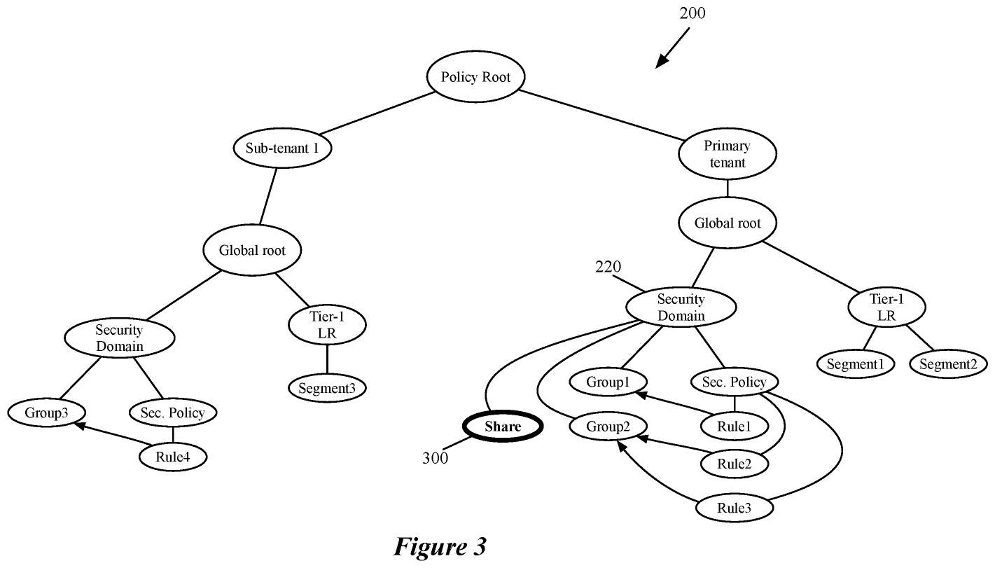

FIG. 3 conceptually illustrates the logical network policy configuration 200 after the primary tenant user has created a shared object 300. As shown, the object is, in this case, defined within the security domain 220. In some embodiments, a user always creates a shared object within a security domain, while in other embodiments shared objects can be defined elsewhere within the policy configuration (e.g., directly underneath the global root), depending on the type of polic constructs the user plans on sharing.

The primary user 105 next sends a command to the network manager 115, via the interface 110, to add a resource to the share. In some embodiments, this command associates one or more previously-created objects, in the policy configuration of the user, with the shared object. As with the previous command, the interface 110 validates the permissions of the primary user 105 and then passes the command to the network manager 115. In some embodiments, each command sent from any user is validated by the interface 110 (performing its RBAC function). This prevents, for instance, a sub-tenant from modifying aspects of the primary tenant policy configuration, even if the sub-tenant is aware of these constructs (e.g., through a shared object).

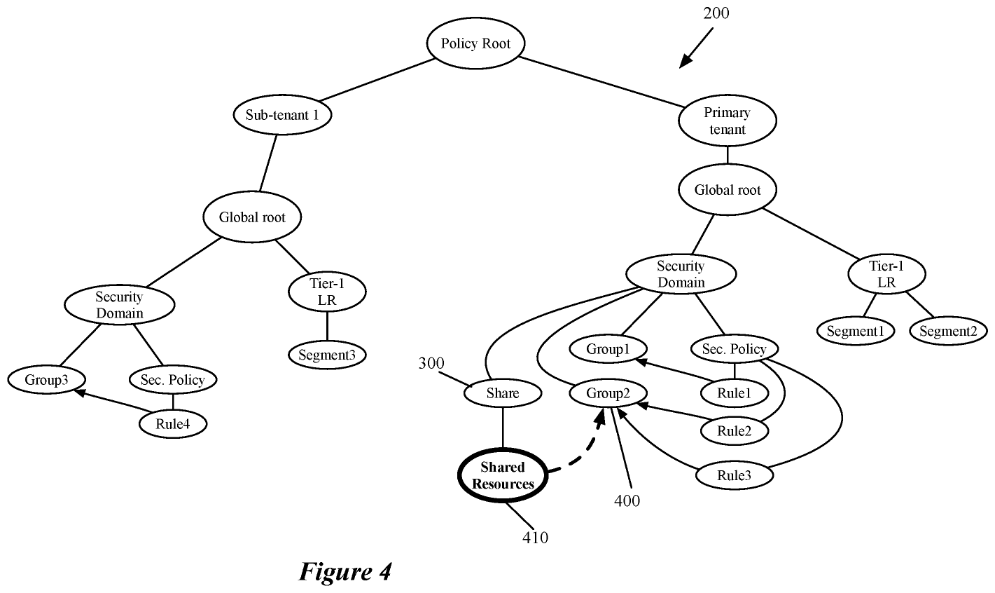

FIG. 4 conceptually illustrates that the second security group 400 has been associated with the shared object 300 in the logical network policy configuration 200. In some embodiments, based on the user associating the security group 400 with created share, the network manager creates a shared resource object 410 within the policy configuration tree 200 (underneath the shared object 300), with this shared resource object 410 pointing to the security group 400 that has been added to the share. In some embodiments, a single shared object 300 may have multiple associated policy configuration objects. In addition to security groups, some embodiments allow for a user to share various policy constructs with other users, including service definitions, service rules, context profiles, and DHCP profiles.

In addition, some embodiments allow users to share logical networking constructs (e.g., logical routers and/or segments) with other users. Different embodiments allow for a single shared object to be used to share security constructs as well as logical networking constructs, while other embodiments require separate shared objects. In some embodiments, a shared object defined within a security domain may only share policy constructs belonging to that security domain (e.g., the shared object 300 can only be used to share constructs from the security domain 220). In this case, users can create shared objects (or multiple different shared objects) within each security domain. A user might want to share one set of policy constructs with a first tenant and another set of policy constructs (from the same security domain) with a second tenant, and thus could define different shared objects to associate with these different sets of policy constructs.

Having defined a shared object and associated a policy construct with that shared object, the primary user 105 sends a command to the network manager 115, via the interface 110, to share that object with another user. As with the previous commands, the interface 110 validates the permissions of the primary user 105 and then passes the command to the network manager 115. The network manager 115 then creates the share to the other user, which enables the other user to access the shared policy constructs.

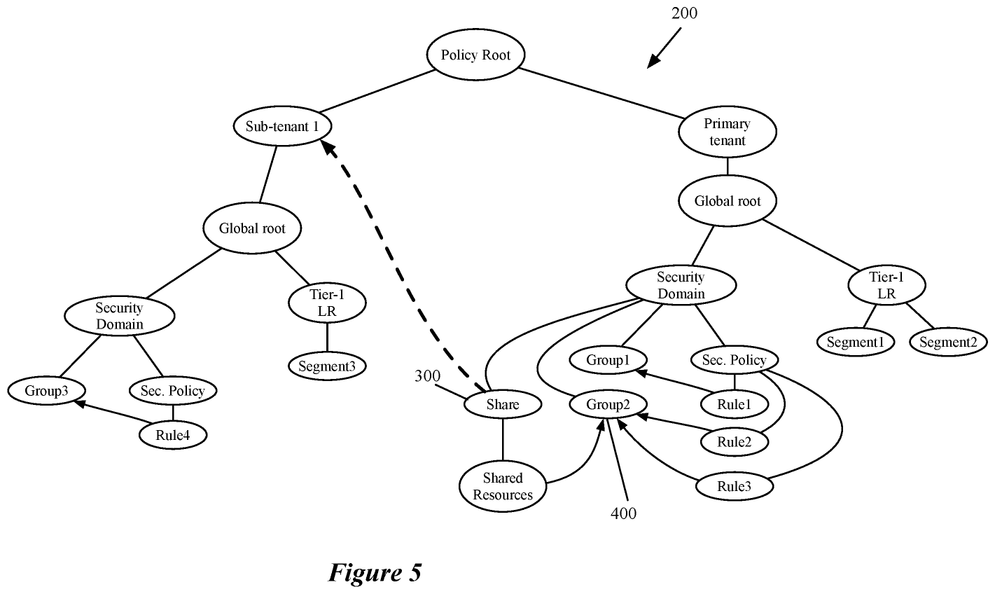

FIG. 5 conceptually illustrates that the primary user has now shared the shared object 300 with the sub-tenant, which enables the sub-tenant to view and use the security group 400. However, while the sub-tenant can use this security group 400, the sub-tenant does not have the ability to make changes to the group. Furthermore, in some embodiments, the sub-tenant cannot view additional information about the group (e.g., the set of IP addresses, network endpoint names, etc. that are associated with the group). In other embodiments, the sub-tenant can view this information (but not modify the group). While this example only shows two users, in some embodiments the tenant that creates a shared object can share that object with multiple other users. For instance, a primary tenant could create a set of service definitions and then share this with all of the sub-tenants so that these sub-tenants do not need to all create the same service definition.

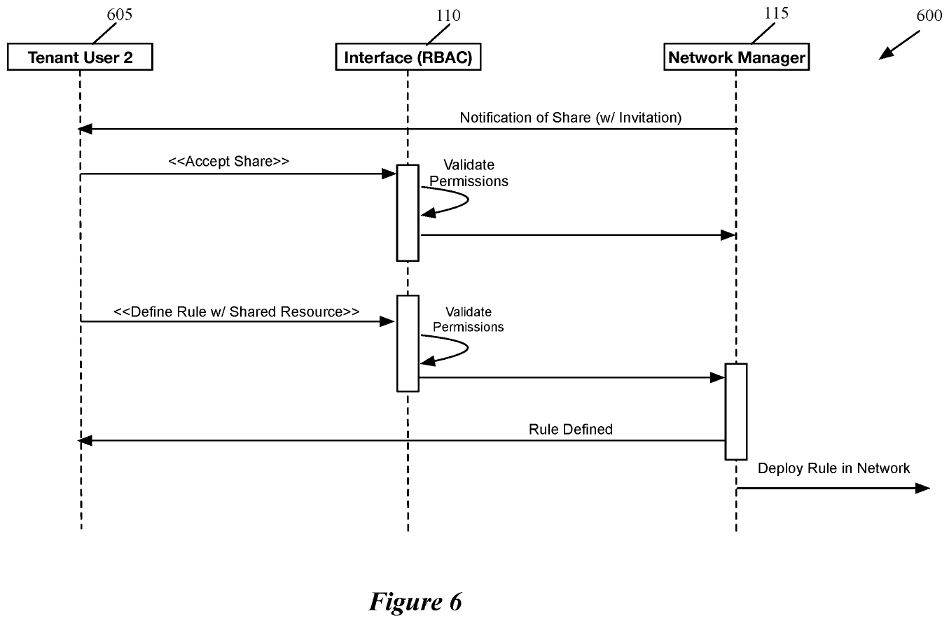

FIG. 6 conceptually illustrates a flow diagram 600 of some embodiments that shows operations of the second tenant user, with which a policy configuration object (e.g., the security group 400) is shared, using that shared policy configuration object. Users with which a policy configuration object is shared have the ability, in some embodiments, to view the policy configuration object (e.g., through the network management service interface) and make use of that policy configuration object. For instance, the user can define a service rule using the policy configuration object (so long as the object is the sort of policy configuration that can be used to define service rules, such as a security group, service definition, etc.).

As shown, once the share has been created and shared with a tenant user, the network manager 115 notifies the tenant user 605 of the shared policy configuration objects. In some embodiments, the network manager 115 notifies the tenant user 605 when the tenant user next accesses the network manager (e.g., logs into the network manager) after the share is created. In some embodiments, notification is not affirmatively sent to the tenant user 605, but instead the shared policy configuration object appears visible (as a useable policy object) to the tenant user 605 when that user logs into the network manager 115.

In other embodiments, as shown in this figure, the user is notified with an invitation to accept the share. In some embodiments, the user with which network policy objects are shared is provided an option as to whether they want to accept the share. In some embodiments, the sharing feature enables a provider (primary) user to share policy objects with tenant users that are defined by the provider user. In other embodiments, one tenant also has the ability to share policy objects with other tenants. Furthermore, as noted above, each tenant user may define their own sub-tenant users in some embodiments, and in some such embodiments these sub-tenant users can share policy objects with each other or with the tenant users. In some such embodiments, the tenant user or sub-tenant user may even share policy objects with the provider user. In some of these embodiments, the tenant or sub-tenant user creates these shared objects in the same manner as described herein for primary user to tenant user sharing. However, a user might not want to use the shared object and in some cases, the shared object might conflict with a user's object. For instance, if one tenant user defines a particular service (e.g., http) in one way and shares this with other tenant users, one of those other tenant users might want to define that service differently and could thus decline the share.

In this example, the tenant user 605 accepts the shared policy object and notifies the network manager 115 of this acceptance (via the interface 110). The interface 110 validates the permissions of the tenant user 605 and provides the acceptance to the network manager 115.

The tenant user 605 then defines a service rule using this shared resource by sending a command to the network manager 115 to create this rule, again via the interface 110. The interface 110 again validates the permissions of the user 605 and then provides the command to the network manager regarding the rule creation (and the specifics of the created rule). In some embodiments, as described above, the tenant user 605 creates this rule within a particular security domain. The network manager 115 creates the new rule within this particular security domain and notifies the user 605 (via the interface 110), who can now view the created rule in their user interface.

In addition, the network manager 115 performs a set of operations to deploy the rule in the network. As described below, these operations may differ in different contexts. Generally, the network manager 115 provides the rule to a set of physical network elements that implement the logical network and its policy. In some embodiments, a global network manager provides the rule to one or more local network managers at each of the relevant datacenters (i.e., datacenters at which the rule needs to be enforced). These local network managers then distribute the rule to the network elements in the datacenter that enforce the rule, in some cases via a set of network controllers. These network elements may be software network elements (e.g., virtual switches, virtual routers, middlebox elements, etc.) such as those implemented in virtualization software of host computers in the datacenters, other software network elements, and/or physical network elements (e.g., physical switches, routers, middlebox appliances, etc.) in various embodiments.

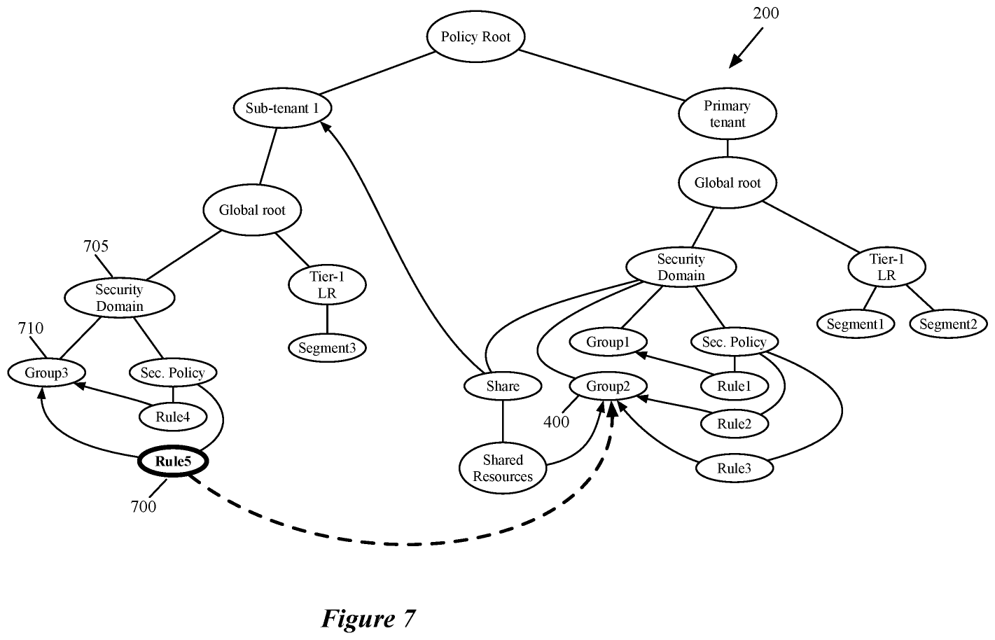

FIG. 7 conceptually illustrates the logical network policy configuration 200 after the sub-tenant has created a new security rule 700 that uses the shared security group 400. As shown, the user defines this new rule 700 as part of the existing security domain 705. The new security rule 700 uses the security group 710 that was previously defined within this security domain 705 as well as the shared security group 400. For instance, the security rule 700 might specify to either block or allow data traffic sent from network endpoints in the security group 710 to network endpoints in the security group 400, or vice versa.

It should be noted that users with which policy configuration objects are shared may perform other operations using these shared policy configuration objects in addition to defining aspects of security rules in some embodiments. For instance, a shared DHCP profile may be used by a tenant to setup DHCP for a portion of the logical network controlled by that tenant user. In addition, in some embodiments logical forwarding elements (e.g., logical routers and/or logical switches can be shared), and a tenant can connect their own logical forwarding elements to these shared elements.

The policy configuration data model described above and sharing of policy configuration objects between users may exist in different contexts in different embodiments. For example, in some embodiments the network management service is a multi-tenant network management and monitoring system that operates in a public cloud to manage multiple different groups of datacenters. In this case, the network management service may have numerous primary users, each a tenant of the network management service with their own independent policy tree. Each primary tenant user defines a group of datacenters (or, in some cases, multiple independent groups of datacenters) and the network management service stores a separate policy tree for each datacenter group. In some embodiments, the network management service deploys a separate policy manager service instance in the public cloud to manage each datacenter group (and thus each separate policy tree).

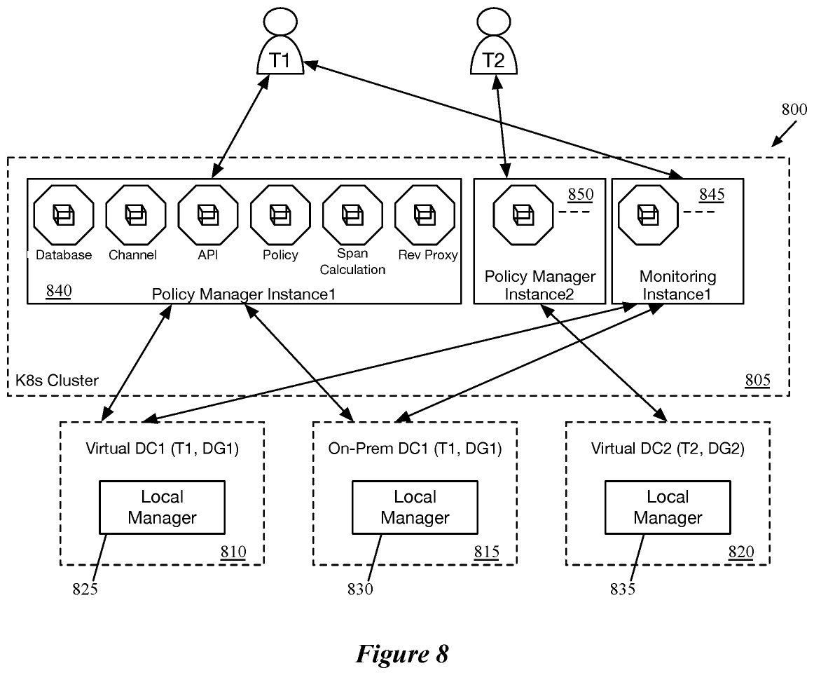

FIG. 8 conceptually illustrates the architecture of such a cloud-based multi-tenant network management and monitoring system 800 of some embodiments. In some embodiments, the network management and monitoring system 800 operates in a container cluster (e.g., a Kubernetes cluster 805, as shown). The network management and monitoring system 800 (also referred to herein as a network management system) manages multiple groups of datacenters for multiple different tenants. For each group of datacenters, the tenant (i.e., primary tenant user) to whom that group of datacenters belongs selects a set of network management services for the network management system to provide (e.g., policy management, network flow monitoring, threat monitoring, etc.). In addition, in some embodiments, a given tenant can have multiple datacenter groups (for which the tenant can select to have the network management system provide the same set of services or different sets of services).

A datacenter group defined by a tenant can include multiple datacenters and multiple types of datacenters in some embodiments. In this example, a first primary tenant (T1) has defined a datacenter group (DG1) including two datacenters 810 and 815 while a second primary tenant (T2) has defined a datacenter group (DG2) including a single datacenter 820. One of the datacenters 810 belonging to T1 as well as the datacenter belonging to T2 are virtual datacenters, while the other datacenter 815 belonging to T1 is a physical on-premises datacenter.

Virtual datacenters, in some embodiments, are established for an enterprise in a public cloud. Such virtual datacenters include both network endpoints (e.g., application data compute nodes) and management components (e.g., local network manager and network controller components) that configure the network within the virtual datacenter. Though operating within a public cloud, in some embodiments the virtual datacenters are assigned to dedicated host computers in the public cloud (i.e., host computers that are not shared with other tenants of the cloud). Virtual datacenters are described in greater detail in U.S. patent application Ser. No. 17/852,917, which is incorporated herein by reference.

The logical network endpoint machines (e.g., virtual machines, containers, etc.) operate at these datacenters 810-820 (e.g., executing on host computers of the datacenters). In addition, the network elements that implement the logical network and enforce logical network policy reside at these datacenters. In some embodiments, these network elements include software switches, routers, and middleboxes executing on host computers as well as physical switches, routers, and or middlebox appliances at the datacenters.

In some embodiments, each network management service for each datacenter group operates as a separate instance in the container cluster 805. In the example, the first tenant T1 has defined both policy management and network monitoring for its datacenter group DG1 while the second tenant T2 has defined only policy management for its datacenter group DG2. Based on this, the container cluster instantiates a policy manager instance 840 and a network monitor instance 845 for the first datacenter group as well as a policy manager instance 850 for the second datacenter group.

The policy management service, in some embodiments, operates as the network management service described above, in which the user can define a logical network that connects logical network endpoint data compute nodes (DCNs) (e.g., virtual machines, containers, etc.) operating in the datacenters as well as various policies for that logical network (defining security groups, firewall rules, edge gateway routing policies, etc.). Through the policy management service, a primary tenant user can define other sub-tenant users, share policy configuration objects with these sub-tenant users, etc.

The policy manager instance 840 for the first datacenter group provides network configuration data to local managers 825 and 830 at the datacenters 810 and 815 while the policy manager instance 850 for the second datacenter group provides network configuration data to the local manager 835 at the datacenter 820. Operations of the policy manager (in a non-cloud-based context) are described in detail in U.S. Pat. Nos. 11,088,919, 11,381,456, and 11,336,556, all of which are incorporated herein by reference.

The network monitoring service, in some embodiments, collects flow and context data from each of the datacenters, correlates this flow and context information, and provides flow statistics information to the user (administrator) regarding the flows in the datacenters. In some embodiments, the network monitoring service also generates firewall rule recommendations based on the collected flow information (e.g., using microsegmentation) and publishes to the datacenters these firewall rules. Operations of the network monitoring service are described in greater detail in U.S. Pat. No. 11,340,931, which is incorporated herein by reference. It should be understood that, while this example (and the other examples shown in this application) only describe a policy management service and a network (flow) monitoring service, some embodiments include the option for a user to deploy other services as well (e.g., a threat monitoring service, a metrics service, a load balancer service, etc.).

In some embodiments, each cloud-based network management service 840-850 of the network management system 800 is implemented as a group of microservices. Each of the network management services includes multiple microservices that perform different functions for the network management service. For instance, the first policy manager instance 840 includes a database microservice (e.g., a Corfu database service that stores network policy configuration via a log), a channel management microservice (e.g., for managing asynchronous replication channels that push configuration to each of the datacenters managed by the policy management service 840), an API microservice (for handling API requests from users to modify and/or query for policy), a policy microservice, a span calculation microservice (for identifying which atomic policy configuration data should be sent to which datacenters), and a reverse proxy microservice. It should be understood that this is not necessarily an exhaustive list of the microservices that make up a policy management service, as different embodiments may include different numbers and types of microservices. In some embodiments, each of the other policy manager service instances includes separate instances of each of these microservices, while the monitoring service instance 845 has its own different microservice instances (e.g., a flow visualization microservice, a user interface microservice, a recommendation generator microservice, a configuration synchronization microservice, etc.). The cloud-based network management system of some embodiments is also described in greater detail in U.S. patent application Ser. No. 18/195,835, filed May 10, 2023, which is incorporated herein by reference.

In other embodiments, the network management service is a network management system that manages a single datacenter or associated group of datacenters (e.g., a set of physical datacenters owned by a single enterprise). Whereas the cloud-based network management system can manage many groups of datacenters for many different tenant users, in some embodiments the network management system has an enterprise that owns and manages a group of datacenters as the primary user (e.g., a network or security administrator of the enterprise). Here, the primary administrator user may define various tenant users representing different departments of the enterprise, tenants of the enterprise (e.g., in the communications service provider context mentioned above), etc.

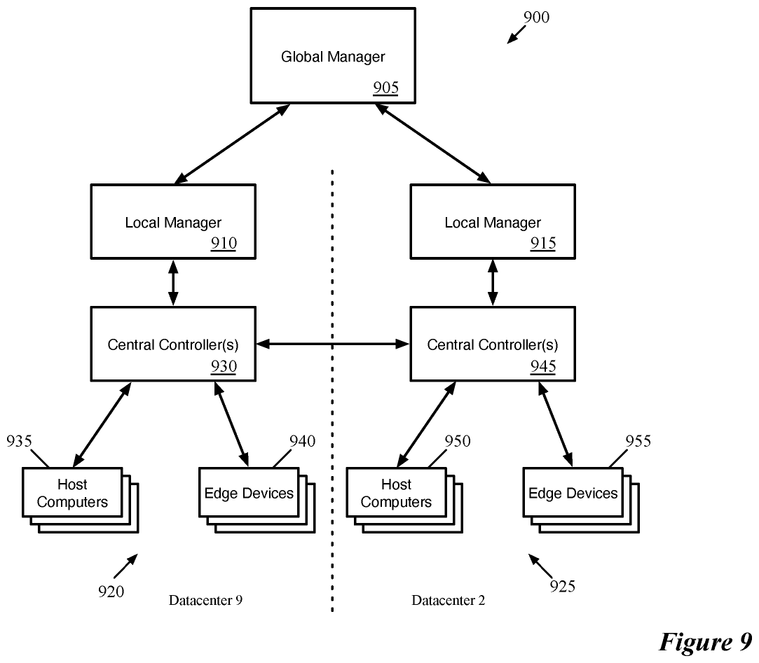

FIG. 9 conceptually illustrates such an enterprise network management system 900 of some embodiments. This network management system 900 includes a global manager 905 as well as local managers 910 and 915 at each of two datacenters 920 and 925. The first datacenter 920 includes central controllers 930 as well as host computers 935 and edge devices 940 in addition to the local manager 910, while the second datacenter 925 includes central controllers 945 as well as host computers 950 and edge devices 955 in addition to the local manager 915.

In some embodiments, the network administrator user defines the logical network to span a set of physical sites (in this case the two illustrated datacenters 920 and 925) through the global manager 905. In addition, any logical network constructs (such as logical forwarding elements) that span multiple datacenters are defined through the global manager 905 (either by the primary user or one of the tenant users). Through the global manager 905, the primary user can define other tenant users and share defined policy configuration constructs with these tenant users in some embodiments.

The global manager 905, in different embodiments, may operate at one of the datacenters (e.g., on the same machine or machines as the local manager at that site or on different machines than the local manager) or at a different site. The global manager 905 provides data to the local managers at each of the sites spanned by the logical network (in this case, local managers 910 and 915). In some embodiments, the global manager 905 identifies, for each logical network construct, the sites spanned by that construct, and only provides information regarding the construct to the identified sites. Thus, security groups, logical routers, etc. that only span the first datacenter 920 will be provided to the local manager 910 and not to the local manager 915. In addition, LFEs (and other logical network constructs) that are exclusive to a site may be defined by a network administrator directly through the local manager at that site. The logical network configuration and the global and local network managers are described in greater detail in U.S. Pat. No. 11,088,919, which is incorporated by reference above.

The local manager 910 or 915 at a given site (or a management plane application, which may be separate from the local manager) uses the logical network configuration data received either from the global manager 905 or directly from a network administrator to generate configuration data for the host computers 935 and 950 and the edge devices 940 and 955 (referred to collectively as computing devices), which implement the logical network. The local managers provide this data to the central controllers 930 and 945, which determine to which computing devices configuration data about each logical network construct should be provided. In some embodiments, different LFEs (and other constructs) span different computing devices, depending on which logical network endpoints operate on the host computers 935 and 950 as well as to which edge devices various LFE constructs are assigned (as described in greater detail below).

The central controllers 930 and 945, in addition to distributing configuration data to the computing devices, receive physical network to logical network mapping data from the computing devices in some embodiments and share this information across datacenters. For instance, in some embodiments, the central controllers 930 receive tunnel endpoint to logical network address mapping data from the host computers 935, and share this information (i) with the other host computers 935 and the edge devices 940 in the first datacenter 920 and (ii) with the central controllers 945 in the second site 925 (so that the central controllers 945 can share this data with the host computers 950 and/or the edge devices 955). Similarly, in some embodiments, the central controllers 930 identify members of security groups in the first datacenter 920 based on information from the host computers 935 and distribute this aggregated information about the security groups to at least the host computers 935 and to the central controllers in the second site 925.

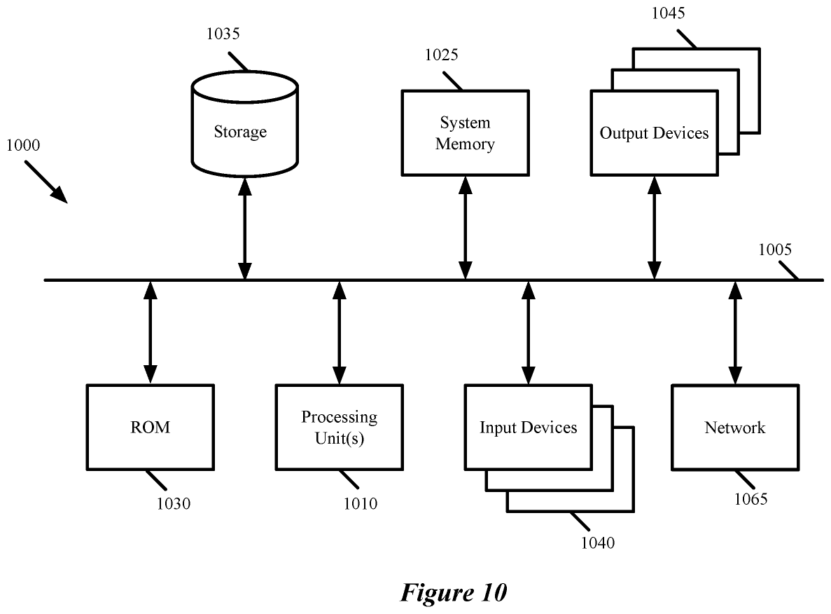

FIG. 10 conceptually illustrates an electronic system 1000 with which some embodiments of the invention are implemented. The electronic system 1000 may be a computer (e.g., a desktop computer, personal computer, tablet computer, server computer, mainframe, a blade computer etc.), phone, PDA, or any other sort of electronic device. Such an electronic system includes various types of computer-readable media and interfaces for various other types of computer-readable media. Electronic system 1000 includes a bus 1005, processing unit(s) 1010, a system memory 1025, a read-only memory 1030, a permanent storage device 1035, input devices 1040, and output devices 1045.

The bus 1005 collectively represents all system, peripheral, and chipset buses that communicatively connect the numerous internal devices of the electronic system 1000. For instance, the bus 1005 communicatively connects the processing unit(s) 1010 with the read-only memory 1030, the system memory 1025, and the permanent storage device 1035.

From these various memory units, the processing unit(s) 1010 retrieve instructions to execute and data to process in order to execute the processes of the invention. The processing unit(s) may be a single processor or a multi-core processor in different embodiments.

The read-only-memory (ROM) 1030 stores static data and instructions that are needed by the processing unit(s) 1010 and other modules of the electronic system 1000. The permanent storage device 1035, on the other hand, is a read-and-write memory device. This device 1035 is a non-volatile memory unit that stores instructions and data even when the electronic system 1000 is off. Some embodiments of the invention use a mass-storage device (such as a magnetic or optical disk and its corresponding disk drive) as the permanent storage device 1035.

Other embodiments use a removable storage device (such as a floppy disk, flash drive, etc.) as the permanent storage device 1035. Like the permanent storage device 1035, the system memory 1025 is a read-and-write memory device. However, unlike storage device 1035, the system memory 1025 is a volatile read-and-write memory, such as random-access memory. The system memory 1025 stores some of the instructions and data that the processor needs at runtime. In some embodiments, the invention's processes are stored in the system memory 1025, the permanent storage device 1035, and/or the read-only memory 1030. From these various memory units, the processing unit(s) 1010 retrieve instructions to execute and data to process in order to execute the processes of some embodiments.

The bus 1005 also connects to the input and output devices 1040 and 1045. The input devices 1040 enable the user to communicate information and select commands to the electronic system 1000. The input devices 1040 include alphanumeric keyboards and pointing devices (also called “cursor control devices”). The output devices 1045 display images generated by the electronic system. The output devices 1045 include printers and display devices, such as cathode ray tubes (CRT) or liquid crystal displays (LCD). Some embodiments include devices such as a touchscreen that function as both input and output devices.

Finally, as shown in FIG. 10, bus 1005 also couples electronic system 1000 to a network 1065 through a network adapter (not shown). In this manner, the computer can be a part of a network of computers (such as a local area network (“LAN”), a wide area network (“WAN”), or an Intranet, or a network of networks, such as the Internet. Any or all components of electronic system 1000 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, are non-VM DCNs that include a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method for managing logical network policy, the method comprising:
at a network management service that manages one or more logical networks, each logical network defined across one or more datacenters:
from a first user that controls a first portion of a logical network, receiving (i) a definition of a policy configuration object for the logical network and (ii) sharing of the policy configuration object with a second user that controls a second portion of the logical network;
from the second user, receiving definition of a service rule that uses the policy configuration object; and
distributing the service rule to a set of network element elements that implement the logical network at the one or more datacenters for the set of network elements to enforce the service rule.

2. The method of claim 1, wherein the first user is a primary user that creates the logical network via the network management service and defines the second user as a tenant user.

3. The method of claim 2, wherein the network management service operates in a public cloud to manage a plurality of logical networks for a plurality of different primary tenant users, each of the plurality of logical networks defined across different groups of datacenters.

4. The method of claim 3, wherein the second user is a sub-tenant of the primary tenant user.

5. The method of claim 2, wherein:
the primary user is associated with a provider for a set of one or more datacenters managed by the network management service; and
the tenant user is one of a plurality of tenant users defined by the second user to control separate portions of the logical network.

6. The method of claim 1, wherein receiving sharing of the policy configuration object comprises receiving (i) creation of a shared object, (ii) association of the policy configuration object with the shared object, and (iii) sharing of the shared object with the second user.

7. The method of claim 6 further comprising receiving association of a plurality of policy configuration objects defined by the first user with the shared object, wherein the plurality of policy configuration objects are available to the second user to define network policy.

8. The method of claim 6 further comprising:
from the first user, receiving sharing of the shared object with a third user;
from the third user, receiving definition of a second service rule that uses the policy configuration object; and
distributing the second service rule to a second set of network elements that implement the logical network at the datacenters for the second set of network elements to enforce the second service rule.

9. The method of claim 1, wherein the first and second users are first and second tenant users that are created by a primary user for the logical network.

10. The method of claim 9, wherein the first and second users control independent first and second portions of the logical network.

11. The method of claim 9, wherein the primary user controls a third portion of the logical network to which the first and second users connect.

12. The method of claim 1 further comprising, based on the sharing of the policy configuration object with the second user:
providing a request to the second user to accept the sharing of the policy configuration object; and
from the second user, receiving acceptance of the shared policy configuration object.

13. The method of claim 1, wherein:
the policy configuration object is a specification for a group of machines that are connected through the logical network; and
the service rule is defined to apply to one of (i) data messages sent from the group of machines and (ii) data messages directed to the group of machines.

14. The method of claim 13, wherein receiving the definition of the policy configuration object comprises receiving a definition of a set of criteria that define the group such that machines connected to the logical network that meet the set of criteria are members of the group.

15. The method of claim 13, wherein receiving the definition of the policy configuration object comprises receiving specification of a set of network addresses corresponding to the machines.

16. The method of claim 1, wherein:
the policy configuration object is a set of criteria defining a service; and
the service rule is defined to apply to data messages belonging to the service

17. The method of claim 16, wherein the service is defined based on a transport layer port number.

18. A non-transitory machine-readable medium storing a program for a network management service that manages one or more logical networks, each logical network defined across one or more datacenters, the program comprising sets of instructions for:
from a first user that controls a first portion of a logical network, receiving (i) a definition of a policy configuration object for the logical network and (ii) sharing of the policy configuration object with a second user that controls a second portion of the logical network;
from the second user, receiving definition of a service rule that uses the policy configuration object; and
distributing the service rule to a set of network element elements that implement the logical network at the one or more datacenters for the set of network elements to enforce the service rule.

19. The non-transitory machine-readable medium of claim 18, wherein the first user is a primary user that creates the logical network via the network management service and defines the second user as a tenant user.

20. The non-transitory machine-readable medium of claim 19, wherein:
the primary user is associated with a provider for a set of one or more datacenters managed by the network management service; and
the tenant user is one of a plurality of tenant users defined by the second user to control separate portions of the logical network.

21. The non-transitory machine-readable medium of claim 18, wherein the set of instructions for receiving sharing of the policy configuration object comprises a set of instructions for receiving (i) creation of a shared object, (ii) association of the policy configuration object with the shared object, and (iii) sharing of the shared object with the second user.

22. The non-transitory machine-readable medium of claim 21, wherein the program further comprises a set of instructions for receiving association of a plurality of policy configuration objects defined by the first user with the shared object, wherein the plurality of policy configuration objects are available to the second user to define network policy.

23. The non-transitory machine-readable medium of claim 21, wherein the program further comprises sets of instructions for:
from the first user, receiving sharing of the shared object with a third user;
from the third user, receiving definition of a second service rule that uses the policy configuration object; and
distributing the second service rule to a second set of network elements that implement the logical network at the datacenters for the second set of network elements to enforce the second service rule.

24. The non-transitory machine-readable medium of claim 18, wherein:
the first and second users are first and second tenant users that are created by a primary user for the logical network;
the first and second users control independent first and second portions of the logical network; and
the primary user controls a third portion of the logical network to which the first and second users connect.

25. The non-transitory machine-readable medium of claim 18, wherein the program further comprises sets of instructions for, based on the sharing of the policy configuration object with the second user:
providing a request to the second user to accept the sharing of the policy configuration object; and
from the second user, receiving acceptance of the shared policy configuration object.
